(19) United States
(12) Patent Application Publication
(10) Pub. No.: US 2014/0313975 A1
(43) Pub. Date: Oct. 23, 2014

(54) WHITE LISTING FOR BINDING IN AD-HOC MESH NETWORKS

(71) Applicant: CUBIC CORPORATION, SAN DIEGO, CA (US)

(72) Inventors: Paul Berenberg, Los Altos, CA (US); Igor Ryshakov, Mountain View, CA (US); Anatoli Gostev, San Jose, CA (US)

(73) Assignee: CUBIC CORPORATION, SAN DIEGO, CA (US)

(21) Appl. No.: 14/255,608

(22) Filed: Apr. 17, 2014

Related U.S. Application Data
(60) Provisional application No. 61/814,101, filed on Apr. 19, 2013.

(51) Int. Cl. H04W 76/02; H04W 84/18

(52) U.S. Cl. CPC H04W 76/021; H04W 84/18
USPC 370/328

(57) ABSTRACT

Techniques are disclosed for specifying and enforcing connections in a network. Embodiments generally include a network device that maintains a data structure that identifies preferred nodes. The data structure includes entries associated with preferred nodes. Connections are established and enforced based on the entries of the data structure. The data structure may be updated and modified allowing network and node reconfiguration.

### CROSS-REFERENCES TO RELATED APPLICATIONS

The present application claims benefit of U.S. Provisional Application No. 61/814,101, filed on Apr. 19, 2013, entitled “White Listing for Binding in Ad-Hoc Mesh Networks” the entire contents of which are incorporated by reference herein for all purposes.

### STATEMENT AS TO RIGHTS TO INVENTIONS MADE UNDER FEDERALLY SPONSORED RESEARCH AND DEVELOPMENT

The U.S. Government may have rights in this invention pursuant to Contract No. ARINC 400-10.

### BACKGROUND OF THE INVENTION

The present invention relates to systems and methods for specifying and creating a network topology.

In many cases mesh network topologies may be generated in an ad-hoc fashion. Networks nodes may be randomly scattered and node connections automatically and organically created by the nodes. In some cases, nodes may be deliberately positioned in specific locations, or next to specific nodes to create a specific topology or network configuration. Nodes that may be adapted to ad-hoc and deliberate topologies and configurations may provide a more useful and resilient network.

### BRIEF SUMMARY OF THE INVENTION

Techniques are disclosed for configuring network nodes for a specific topology. Network nodes may be configured to automatically determine the nearest nodes and create and ad-hoc network. The same nodes may be configured to connect to specific nodes. Connections between specific nodes may be enforced. Nodes may be configured to include a network connection table or a “white-list” table that may configure a node for connection with a preferred neighboring node or may be used to create or enforce a specific network topology or configuration.

According to an embodiment, a system for defining connectivity of a node of a network is provided. The system may include a data structure comprising one or more entries. Each entry may include a MAC address field, and a permissions field. The permissions field may be configured to define connection permissions of the node with the MAC address of the MAC address field. The system may further include a connection module configured to enforce connections according to a white-list table. The connections may be enforced by identifying a neighboring node within communication distance of the node, receiving a MAC address of the neighboring node, locating entries in the white-list table corresponding to the received MAC address, and establishing a connection with the neighboring node corresponding to the received MAC address located in the white-list table. In embodiments of the system, the connection module may be configured to establish the connection according to default permissions when the received MAC address does not match entries in the white-list table. In some cases at least one entry in the white-list table may correspond to a plurality of MAC addresses. In embodiments the system may also include an update module. The update module may be configured to cause the node to receive white-list table updates. The update module may be configured to signal the connection module to reestablish the connection according to the white-list table when updates to the white-list table are received. The update module may be further configured to cause the node to search for a second node with a second MAC address matching entries in the white-list table.

According to another embodiment, there is provided a method for defining connectivity of a node of a network. The method may include identifying a neighboring node within communication distance of the node and receiving a MAC address of the neighboring node. The method may further include locating entries in a white-list table corresponding to the received MAC address. In embodiments the white-list table may store entries of preferred MAC addresses for establishing connections. The method may also include establishing a connection with the neighboring node corresponding to the MAC address located in the white-list table. Each entry in the white-list table may also include permissions associated with each MAC address. The method may also include establishing the connection according to default permissions when the received MAC address does not match entries in the white-list table. In some cases at least one entry in the white-list table corresponds to a plurality of MAC addresses. The method may also further include receiving white-list table updates. When updates to the white-list table are received, connections may be reestablished according to the updated white-list table. The method may also include searching for a second node with a second MAC address matching entries in the white-list table.

According to another embodiment, there is provided a node of a network. The node may include one or more processors and a non-transitory computer-readable storage medium storing a plurality of instructions, which, when executed by the one or more processors, cause the node to identify a neighboring node within communication distance of the node. The instructions may also cause the node to receive a MAC address of the neighboring node and locate an entry in a white-list table corresponding to the received MAC address. The white-list table may store entries of preferred MAC addresses for establishing connections. The instructions may also cause the node to establish a connection with the neighboring node corresponding to the MAC address located in the white-list table.

### BRIEF DESCRIPTION OF THE DRAWINGS

FIG. 1 is a block diagram of an embodiment of a wireless network.

FIGS. 2A and 2B are example embodiment of white-list tables.

FIG. 3 is an embodiment of a wireless sensor device.

FIG. 4 is a block diagram of an embodiment of a wireless network.

FIG. 5 is a block diagram of an embodiment of a white-list processing system.

FIG. 6 is an embodiment of a method for using a white-list table in a network.

### DETAILED DESCRIPTION OF THE INVENTION

Nodes in a wireless mesh networks are often arbitrarily positioned without consideration for a network topology or a specific network configuration. Nodes of the network, such as sensors and actuators may be positioned and repositioned in an area for monitoring and/or control applications. In many cases the position of nodes is dictated by the environment or application without consideration for a network topology. The nodes of such networks may be configured to establish connections with other nodes to create mesh networks. Mesh networks may have arbitrary or automatically determined connectivity between nodes without an enforced connectivity or hierarchy.

In some applications, one or more of the nodes in a network may be deliberately positioned or configured in the network. In some applications or environments, one or more nodes may be deliberately positioned near other nodes of the network or the nodes in the network may be arranged in a specific topology. Connections between nodes may be deliberately and explicitly enforced by a network manager to improve reliability, performance, and/or other parameters.

For example, in one application, sensor nodes may be deployed randomly across an environment (e.g. deployed from an airplane). The nodes may connect (wirelessly) to each other to create an ad-hoc mesh network of sensor nodes. After the nodes have been deployed, the autonomously generated network topology may be analyzed to determine reliability or performance bottlenecks. In some cases, small changes to some of the network connections may improve the reliability and/or performance of the network. A network manager may determine specific node connections that may be deliberately enforced to resolve identified network weaknesses.

In another example, nodes with actuators may be deployed across a factory according to control demands. Specific types of additional sensor nodes may be positioned near the actuator nodes for providing readings and control signals for the actuator nodes. In many applications it may be desirable to deliberately enforce direct communication between the sensor node and actuator node of the network.

Embodiments of the present invention provide methods and systems for specifying and enforcing deliberate communication links between nodes in a wireless mesh network. Embodiments provided herein may be utilized in virtually all wireless mesh networks: logistics asset tracking, industrial control and monitoring, building control, etc.

In embodiments, a node may be configured to receive and/or store a configuration data and/or configuration table (“white-list” data) that identifies preferred connections between the node and other nodes. The table may include identification of the preferred nodes' media access control (MAC) addresses. In some embodiments the configuration data and/or configuration table may include preferred backup nodes' MAC addresses and a preferred secondary nodes' MAC addresses. The configuration data may specify settings or algorithms for detecting preferred nodes, connecting to preferred nodes, settings for actions when preferred nodes are not detected, and/or the like. Nodes of a network may be configured to automatically determine suitable connections according to mesh or ad-hoc network connection algorithms or may be configured to connect to specific preferred nodes. Using a “white-list” table, the connections of a node may be changed from ad-hoc to deliberate and vice-versa.

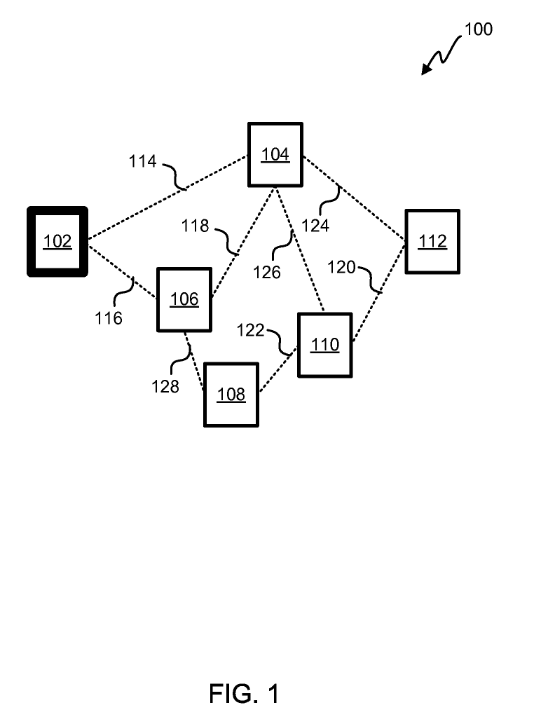

FIG. 1 shows a topology of one example of a mesh network 100 which may utilize the techniques described herein. The network 100 includes nodes 102, 104, 106, 108, 110, 112 and communication links 114, 116, 118, 120, 122, 124, 126, 128 between the nodes. The communication links may be physical (i.e., a conventional wire), wireless, virtual, and the like. The nodes in the network may be of the same type or maybe different with different computational capabilities for example. Some nodes may be fixed, other movable. The topology of the network may change as the nodes move in the network.

Typically, wireless mesh networks may form in semi random fashion around gateways or network coordinators 102. A gateway or a coordinator 102 may be the central hub of the network. A gateway may provide a connection to the outside world. A coordinator may manage network synchronization and addressing. In some embodiments, when a network is first configured, the gateway (or a coordinator) may advertise itself for connections by transmitting beacon frames. Wireless nodes in range of the gateway may establish wireless links to the gateway. They in turn may start advertising themselves as intermediate nodes on the path to the gateway. Other nodes establish communication links to these nodes and the process continues. The topology of the network may depend on which devices are in radio range of other devices and which node captured the beacon first. Communication links between nodes may be established by exchanging handshakes with a node MAC address that is unique to each node. The MAC address of each frame or other unique identifiers may be used to uniquely identify each node and establish connections. In embodiments, the MAC address can be an 8-byte long IEEE EUI-64 source address or identifier.

Nodes may be configured to enforce specific connections to one or more other nodes in the network. Specific node connections may be defined by a configuration table or a “white-list” table that identifies connections rules or preferred MAC address identifiers for establishing communication links. When a node receives advertisements for connections from other nodes, the node may check its white-list table to determine if they match one of the entries in its table. The node may compare received MAC addresses or other unique node identifiers and compare them against MAC addresses stored in its white-list table. If one or more of the received MAC addresses of the advertisements match the table entries, the nodes corresponding to the matching MAC addresses may be given connection priority.

In embodiments, the configuration table or white-list table may be a table or other data structure with entries and fields that define a set of preferred connection nodes. The entries and fields may define which connections are allowed and which connections should be rejected or ignored (black-list table). The table may include one or more entries with each entry having one or more fields. In embodiments, each entry in the table may include a MAC address identifier field. The MAC address identifier field may store unique node identifiers, MAC addresses, range of identifiers, or a list of identifiers. Each entry in the table may also include a “permissions” field. The permissions field may define if the one or more nodes defined in the MAC field of the entry is a preferred node, if the connections should be rejected, and types of connections allowed (e.g. child, parent, etc.).

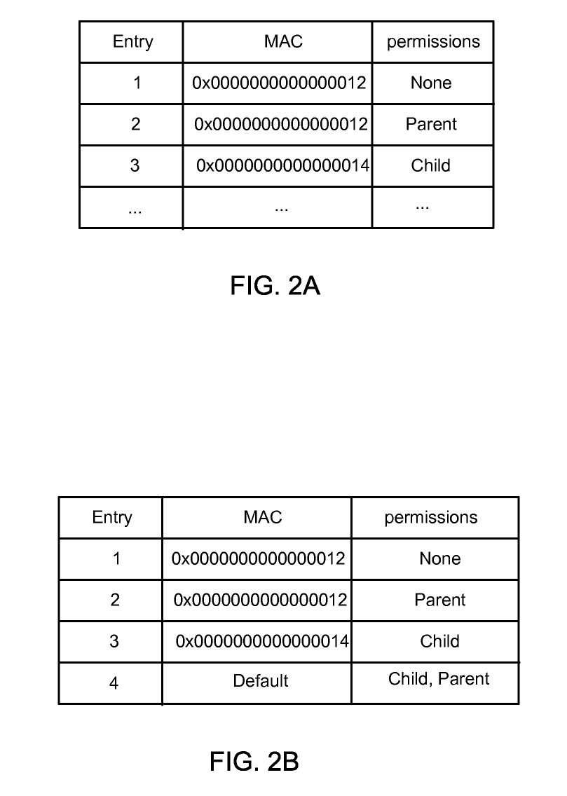

FIG. 2A depicts one example embodiment of a white-list table with three entries and two fields for storing the MAC or other unique identifier and the permissions. The data associated with each field may be encoded or stored in the table as a Boolean flag, string, or any other suitable representation.

In embodiments, a white-list table may include additional parameters that define default behavior and/or algorithms that may define actions of behaviors if preferred nodes from the white-table are not available. In embodiments the white-list table may further include parameters related to “default permissions”. The default permissions may list allowed connection types for MAC addresses not found in the white-list table.

FIG. 2B depicts one example embodiment of a white-list table wherein one of the entries of the table defines default permissions. In one embodiment, one entry of the table may be designated as the default behavior by using a special entry in the MAC field. A reserved value, such as all zeros for example, may be used to define that the entry is used to define the default behavior or permissions. In some embodiments the default permissions may include designators such as “none” which indicate that only the connections in the white-list table are allowed. In some embodiments other connections may be limited to only “parent” or only “child”.

In some embodiments, nodes may have a maximum number of wireless links they can support. In some cases, some nodes that may be listed in the white-list may be ignored due to limited number of connections. In some cases, communication links with some nodes that are listed in the white-list may be abandon and replaced with higher priority nodes listed in the white-list.

In some embodiments, the MAC address field of the white-list table can also be a multicast address assigned to a group of nodes. In this case bindings can be enforced in certain groups of nodes or between groups. In some cases, the MAC address field may specify a MAC address mask to the entries in the table. A mask may be applied to the MAC address before matching. A mask may be used, for example, for filtering node hardware manufacturers.

In embodiments where the white-list table is at least partially stored in non-volatile memory such as flash memory the data in the fields may be encoded to extend the life span of the memory. It is to be understood that although the white-list table is presented diagrammatically as table, it may be implemented and arranged in memory of the node in any number of ways. The table may be stored and arranged in memory as a flat file, indexed file, hash table, linked list, etc. Each record of the table may include additional fields such as routing directives, connection lifetimes, and the like.

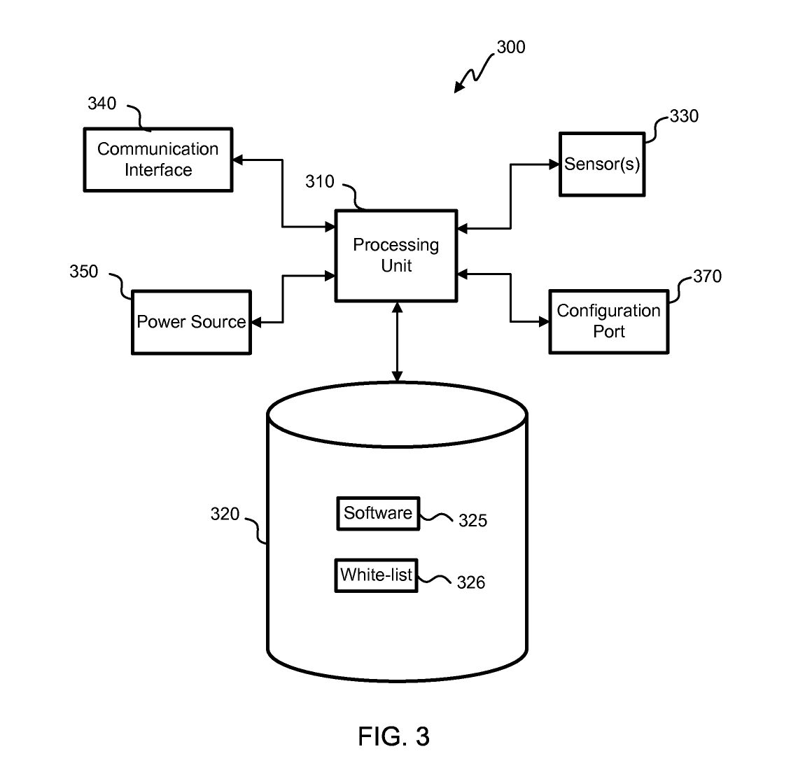

FIG. 3 is a block diagram of an embodiment of a network node that may utilize the white-list table structure depicted in FIGS. 2A and 2B. This node may include components such as the sensor(s) 330, processing unit 310, memory 320, and a communication interface 340 which may be wireless. In some embodiments, the components may be optimized for cost and/or power consumption. For example, the processing unit 310 can comprise a microprocessor and the memory 320 and software 325 can comprise programmed logic of the microprocessor. The node 300 may further include a power source 350 such as a battery, solar array, fuel cell, or other source of electrical energy. The memory 320 may include the white-table 326 that may store connection preferences. The software 325 may include algorithms and protocols for establishing connections between different nodes.

The white-list table may in some nodes be pre-loaded and defined before the node is deployed. In some embodiments, the white-list table and preferences may be defined and/or updated after the node is deployed. The table and any additional preferences may be added to the memory 320 of the node 300 via wireless update protocols such as the simple network management protocol (SNMP). New or updated white-list tables may be sent to the node 300 via the communication interface 340 or the configuration port 370 of the node 300.

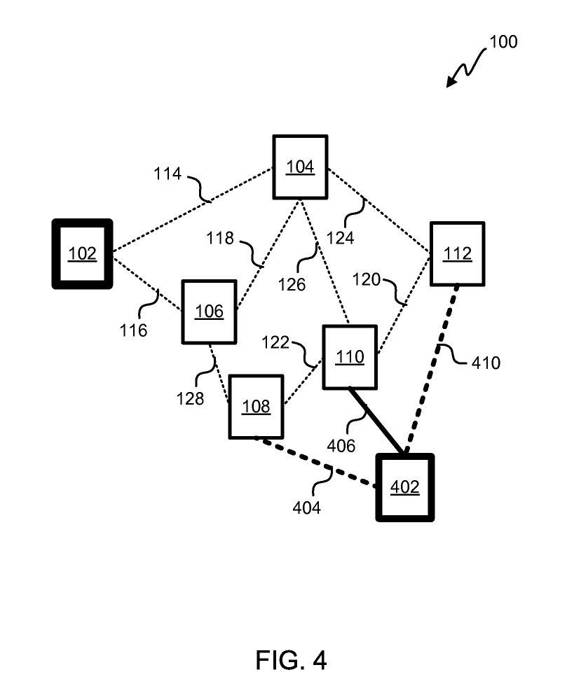

Returning now to the example network 100, a node in the network 100 may be configured to connect to specific nodes using the white-list table. For example, as depicted in FIG. 4, a new node 402 may be added to the network. In some embodiments, when the node is added the network it may automatically detect other available nodes. The new node may generate communication connections in an ad-hoc fashion. In some cases, however, it may be desirable or necessary to enforce a specific connection between the nodes. In one example, the new node 402 may be a sensor node configured to provide control signals to another node 110 which may include actuators. A specific or deliberate enforcement of a communication link may be necessary to reduce network delay or increase reliability. When the node 402 is added to the network, the node may include a white-list table that lists the MAC address or other unique identifier of node 110. The white-list table may identify node 110 as the preferred node. In addition, the white-list table may include the MAC address of node 108 as preferred backup in case the preferred connection to node 110 is not available.

When the new node 402 is added to the network, the node may initiate a discovery procedure to determine available nodes within communication distance. During the discovery procedure nodes 108, 110, and 112 may be identified. The MAC addresses of the nodes may be compared with the entries in the white-list table. The MAC address associated with node 110 may be identified as the preferred communication node and a connection 406 can be established only with node 110. If the communication with node 110 is disrupted, the communication link 404 with the preferred backup node 108 may be established. If none of the MAC entries in the white-list table match the MAC addresses of the identified nodes during the discovery phase, action may be taken by the node according to the default behavior specified in the white-list table. In some configurations, the node may establish links with all available nodes 108,110, 112. In some configurations, the node may ignore the nodes and periodically check for new available nodes until a node that matches the MAC address of an entry on the white-list table is identified.

Based on the entries in the white-list and definition of default behavior there may be several different permutations of parameters leading to different behavior. The behavior may depend on the parameters of the two nodes in a connection. For example, several scenarios are outlined below for a configuration where node A (server/parent node) is a new node that discovers node B (potential client/child node).

Scenario 1: Both Node A and Node B have no entries in white-list table. Both nodes may operate according to their default permissions and Node A can accept any node without preferences, node B can connect to any node without preferences.

| Node A | | Node B | |
|---|---|---|---|
| Default permissions: parent, child | | Default permissions: parent, child | |
| White List Table | | White List Table | |
| MAC | Permissions | MAC | Permissions |
| None | None | None | None |

Scenario 2: Node B has Node A in its white-list. Node A can accept any node without preferences. When available Node B would prefer to connect to Node A but can connect to any node.

| Node A | | Node B | |
|---|---|---|---|
| Default permissions: parent, child | | Default permissions: parent, child | |
| White List Table | | White, List Table | |
| MAC | Permissions | MAC | Permissions |
| None | None | A | Parent |

Scenario 3: Node B has Node A in its white-list. Node A has no entries in the white-list and can accept any node according to default permissions. Node B can connect only to node A.

| Node A | | Node B | |
|---|---|---|---|
| Default permissions: parent, child | | Default permissions: none or child | |
| White List Table | | White List Table | |
| MAC | Permissions | MAC | Permissions |
| None | None | A | Parent |

Scenario 4: Node A has Node B in its white-list. Node A would prefer to accept node B but can accept any node, node B can connect to any node without preferences.

| Node A | | Node B | |
|---|---|---|---|
| Default permissions: parent, child | | Default permissions: parent, child | |
| White List Table | | White List Table | |
| MAC | Permissions | MAC | Permissions |
| B | Child | None | None |

Scenario 5: Node A has Node B in its white-list and Node B has Node A in its white-list. Node A would prefer to accept node B but can accept any node, node B would prefer to connect to node A but can connect to any node.

| Node A | | Node B | |
|---|---|---|---|
| Default permissions: parent, child | | Default permissions: parent, child | |
| White List Table | | White List Table | |
| MAC | Permissions | MAC | Permissions |
| B | Child | A | Parent |

Scenario 6: Node A would prefer to accept node B but can accept any node, node B can connect only to node A.

| Node A | | Node B | |
|---|---|---|---|
| Default permissions: parent, child | | Default permissions: none or child | |
| White List Table | | White List Table | |
| MAC | Permissions | MAC | Permissions |
| B | Child | A | Parent |

Scenario 7: Node A can accept only node B, node B can connect to any node without preferences.

| Node A | | | |
|---|---|---|---|
| Default permissions: | | Node B | |
| none or parent | | Default permissions: none | |
| White List Table | | White List Table | |
| MAC | Permissions | MAC | Permissions |
| B | Child | None | None |

Scenario 8: Node A can accept only node B, node B would prefer to connect to node A but can connect to any node.

| Node A | | | |
|---|---|---|---|
| Default permissions: | | Node B | |
| none or parent | | Default permissions: parent, child | |
| White List Table | | White List Table | |
| MAC | Permissions | MAC | Permissions |
| B | Child | A | Parent |

Scenario 9: Node A can accept only node B, node B can connect only to node A:

| Node A | | | |
|---|---|---|---|
| Default permissions: | | Node B | |
| none or parent | | Default permissions: none or child | |
| White List Table | | White List Table | |
| MAC | Permissions | MAC | Permissions |
| B | Child | A | Parent |

Scenario 10: Nodes A and B can be exclusively interconnected regardless who is parent and who is child.

| Node A | | Node B | |
|---|---|---|---|
| Default permissions: none | | Default permissions: none | |
| White List Table | | White List Table | |
| MAC | Permissions | MAC | Permissions |
| B | Parent, child | A | Parent, child |

Scenario 11: Nodes A and B can be preferably interconnected regardless who is parent and who is child.

| Node A | | Node B | |
|---|---|---|---|
| Default permissions: parent, child | | Default permissions: parent, child | |
| White List Table | | White List Table | |
| MAC | Permissions | MAC | Permissions |
| B | Parent, child | A | Parent, child |

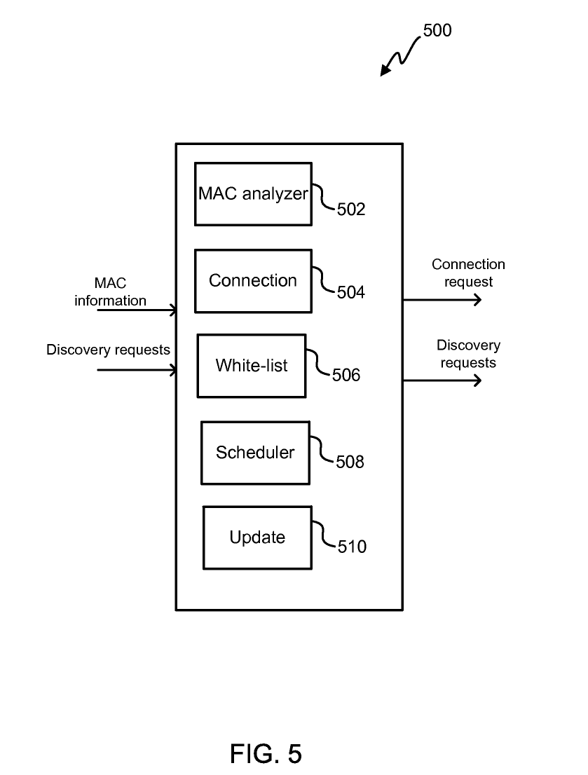

The components and modules of an embodiment of a white-list processing and connection system of a node are depicted in FIG. 5. Modules shown in FIG. 5 may be implemented in hardware and/or software by, for example, one or more of the components of a node as described in relation to FIG. 3. A white-list processing system 500, may take as input packets from other nodes that may include unique node identifiers such as a MAC address. The system 500 may also receive discovery requests or “pings” from other nodes requesting identification. The system may also send out discovery requests to other nodes and send connection requests to identified nodes.

In embodiments, the white-list processing system 500 may include a MAC analyzer module 502. The MAC analyzer module may processes received requests, packets, and identify the unique identifier such as the MAC address. In some cases unique identifiers may be encrypted or require decoding or deciphering. The received or deciphered MAC address may be compared against the white-list 506 of the system 500. The white-list 506 may be a table or other data structure stored in the system. The white-list may identify MAC addresses associated with preferred nodes. The white-list may identify default permissions or behavior when preferred nodes or MAC addresses are not listed on the white-list. The connections may be processed and established by the connection module 504. The connection module may enforce communication and connection restrictions based on the white-list and default permissions. The connection module may initiate and/or store algorithms for initiating and managing connections. In the scenarios where connections are not feasible due to restrictions of the white-list or unavailability of preferred nodes, the connection module may be configured to initiate discovery of other nodes until a preferred node is found. In some embodiments, a scheduler module 508 may be used by the connection module 504 to coordinate or schedule discovery procedures based on network activity, available power, and/or the like.

In embodiments, the system 500 may further include an update module 510 that may be configured to update the white-list 506 of the system. The update module may receive updated white-list definitions via the network using network update protocols such as SNMP. When updates are received the update module 510 may evaluate changes to the white-list and determine if established connections may need to be terminated based on the new definitions. The update module may signal the connection module 504 and the scheduler 508 to initiate discovery to establish communication with other nodes.

It is to be understood that the structure, order, and number of modules, blocks, and the like shown and described in the figures of this disclosure may be changed or altered without deviating from the spirit of the disclosure. Modules may be combined or divided into multiple other modules, for example. They functionality of the modules may be implemented with software, scripts, hardware and the like. For example, modules, such as the scheduler module 508 and the connection module 504 of the system 500 depicted in FIG. 5 may be implemented as a software module, an application specific integrated circuit, as logic in a field programmable gate array, and the like.

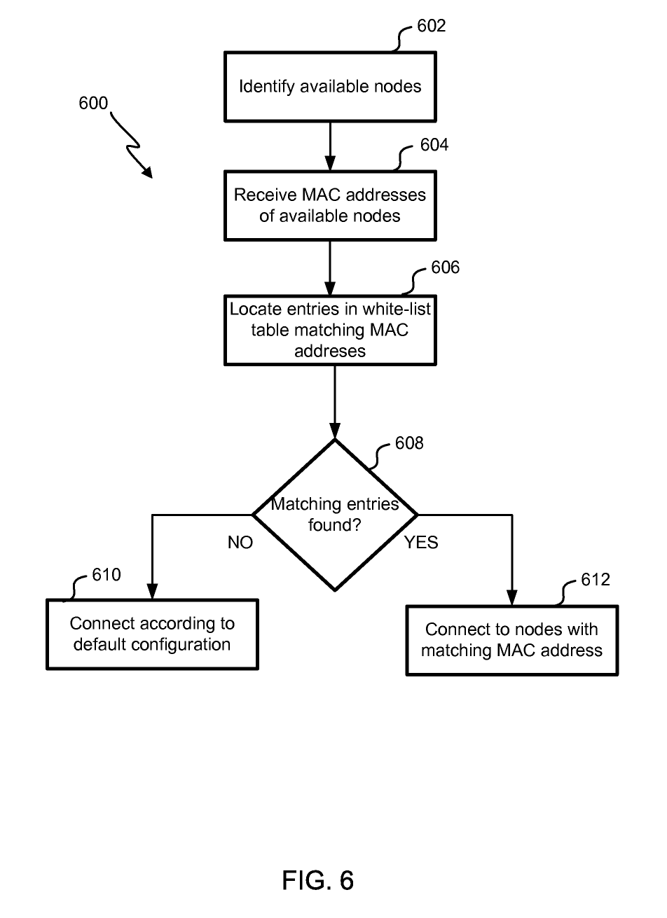

FIG. 6 shows an embodiment of a method 600 for using a white-list table in a network. Unique identifiers listed in a white-list table may be used to manage connection between nodes in a network. Steps of the method shown in FIG. 6 may be implemented in hardware and/or software by, for example, one or more of the components or modules of the packet tracking system as described in relation to FIG. 5. A white-list table may be structured as the table in FIG. 2A or 2B where each entry includes a filed for a MAC address and permissions. In step 602 a node may first determine available nodes within communication distance of the node. The node may receive communication requests from other nodes. The node may initiate a node discovery algorithm for locating other nodes and receive a communication with unique identifiers such as MAC addresses. In step 604 the MAC addresses of the available nodes may be collected and in step 606 the collected MAC addresses may be compared to entries in the white-list table. If no matching entries can be found in the white list table the node may use default permissions and settings in step 610 to determine if the node should establish connections with one or more of the identified nodes. In some cases the default permissions may restrict the node to connection with one of the preferred nodes listed in the white-list table. In some cases when a node is not found in the white-list table the node may be configured to connect to any available node in the network. If one or more of the received MAC addresses matches entries in the white-list table, in step 612 the node may connect to the nodes according to the priority listed in the white-list.

In the description herein, for the purposes of explanation, numerous specific details are set forth in order to provide a thorough understanding of various embodiments. It will be apparent, however, to one skilled in the art that various embodiments may be practiced without some of these specific details. In other instances, well-known structures and devices are shown in block diagram form.

The description also provides exemplary embodiments only, and is not intended to limit the scope, applicability, or configuration of the disclosure. Rather, the preceding description of the exemplary embodiments will provide those skilled in the art with an enabling description for implementing an exemplary embodiment. It should be understood that various changes may be made in the function and arrangement of elements without departing from the spirit and scope of the disclosed systems and methods as set forth in the appended claims.

Specific details are given in the above description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function. It should also be appreciated that the methods described above may be performed by hardware components or may be embodied in sequences of machine-readable instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

What is claimed is:

1. A node of a network, the node comprising:
one or more processors; and
a non-transitory computer-readable storage medium storing a plurality of instructions, which, when executed by the one or more processors, cause the node to:
identify a neighboring node within communication distance of the node;
receive a MAC address of the neighboring node;
locate an entry in a white-list table corresponding to the received MAC address, wherein the white-list table stores entries of preferred MAC addresses for establishing connections; and
establish a connection with the neighboring node corresponding to the MAC address located in the white-list table.

2. The node of claim 1, wherein each entry in the white-list table further includes permissions associated with each MAC address.

3. The node of claim 1, wherein the instructions further cause the node to establish the connection according to default permissions when the received MAC address does not match entries of the white-list table.

4. The node of claim 1, wherein at least one entry in the white-list table corresponds to a plurality of MAC addresses.

5. The node of claim 1, wherein the instructions further cause the node to receive white-list table updates.

6. The node of claim 3, wherein the instructions further cause the node to search for a second node with a second MAC address matching entries in the white-list table.

7. The node of claim 5, wherein the instructions further cause the node to reestablish the connection according to the white-list table when updates to the white-list table are received.

8. A system for defining connectivity of a node of a network, the system comprising:
a data structure comprising one or more entries, wherein each entry comprises:
a MAC address field, and
a permissions field, the permissions field configured to define connection permissions of the node with the MAC address of the MAC address field; and
a connection module configured to enforce connections according to a white-list table by:
identifying a neighboring node within communication distance of the node;
receiving a MAC address of the neighboring node;
locating entries in the white-list table corresponding to the received MAC address; and
establishing a connection with the neighboring node corresponding to the received MAC address located in the white-list table.

9. The system of claim 8, wherein the connection module is further configured to establish the connection according to default permissions when the received MAC address does not match entries in the white-list table.

10. The system of claim 8, wherein at least one entry in the white-list table corresponds to a plurality of MAC addresses.

11. The system of claim 8, further comprising an update module wherein the update module is configured to cause the node to receive white-list table updates.

12. The system of claim 11, wherein the update module is configured to signal the connection module to reestablish the connection according to the white-list table when updates to the white-list table are received.

13. The system of claim 11, wherein the update module is configured to cause the node to search for a second node with a second MAC address matching entries in the white-list table.

14. A method for defining connectivity of a node of a network, the method comprising:
identifying a neighboring node within communication distance of the node;
receiving a MAC address of the neighboring node;
locating entries in a white-list table corresponding to the received MAC address, wherein the white-list table stores entries of preferred MAC addresses for establishing connections; and
establishing a connection with the neighboring node corresponding to the MAC address located in the white-list table.

15. The method of claim 14, wherein each entry in the white-list table further includes permissions associated with each MAC address.

16. The method of claim 14, further comprising establishing the connection according to default permissions when the received MAC address does not match entries in the white-list table.

17. The method of claim 14, wherein at least one entry in the white-list table corresponds to a plurality of MAC addresses.

18. The method of claim 14, further comprising receiving white-list table updates.

19. The method of claim 16, further comprising searching for a second node with a second MAC address matching entries in the white-list table.

20. The method of claim 18, further comprising reestablishing connections according to the white-list table when updates to the white-list table are received.
